(19) United States
(12) Patent Application Publication
(10) Pub. No.: US 2021/0144489 A1
(43) Pub. Date: May 13, 2021

(54) METHOD FOR OPERATING A NETWORK, AND HEARING DEVICE

(71) Applicant: Sivantos Pte. Ltd., Singapore (SG)

(72) Inventors: Umut GOEKAY, Koenigswinter (DE); Frank NAUMANN, Bubenreuth (DE)

(21) Appl. No.: 17/095,040

(22) Filed: Nov. 11, 2020

(30) Foreign Application Priority Data
Nov. 11, 2019 (DE) 10 2019 217 399

(51) Int. Cl. H04R 25/00; H04L 29/08; H04L 29/12

(52) U.S. Cl. CPC H04R 25/554; H04R 25/558; H04L 67/1042; H04L 61/6068; H04L 67/125

(57) ABSTRACT

A method for operating a network is specified. The network has a plurality of hearing devices assigned to different users. Each of the hearing devices has an interface and is connected via this interface to at least one of the other hearing devices for the exchange of data with this hearing device and the other hearing devices. The network can be divided into a plurality of subnets, which are then connected to each other by configuring one of the hearing devices as a gateway in each of the subnets for the exchange of data between hearing devices of different subnets. Each of the hearing devices is assigned to exactly one subnet and is dynamically assigned to another, existing subnet or to a new subnet in order to increase transmission quality during the data exchange. A hearing device for implementing the method is also specified.

### CROSS-REFERENCE TO RELATED APPLICATION

This application claims the priority, under 35 U.S.C. § 119, of German application DE 10 2019 217 399, filed Nov. 11, 2019; the prior application is herewith incorporated by reference in its entirety.

### BACKGROUND OF THE INVENTION

### Field of the Invention

The invention relates to a method for operating a network having a plurality of hearing devices, and to a corresponding hearing device.

A hearing device is usually assigned to an individual user and is worn by the user in or on the ear to capture sound from the environment and to output it again in modified form. To this end the hearing device has a microphone, which captures the acoustic signals and converts them into an electrical input signal. This is fed to a signal processor of the hearing device for modification. As a result the signal processor outputs an electrical output signal, which is then converted back into sound via a receiver of the hearing device.

If multiple users each with a hearing device meet together at the same place, it can be useful for hearing devices to connect to each other in a network to exchange data. Hearing devices of different users that are connected together in a network are described, for example, in published, European patent applications EP 1 643 801 A2 and EP 3 101 919 A1, corresponding to U.S. patent publications 2006/0067550 and 2006/0067549 and U.S. Pat. No. 9,949,040.

For data exchange in a network, a hearing device has an interface, but the operation of this is typically very energy-intensive. This is particularly problematic in the case of hearing devices which are mobile devices and are therefore not connected to a fixed power supply but supplied with power by means of an energy storage unit installed in the hearing device. As a result, the range of the interface is often limited to a few meters or even less, making it difficult to exchange data with hearing devices located far away.

### BRIEF SUMMARY OF THE INVENTION

Against this background, an object of the invention is to improve the networking of hearing devices in a shared network. The networking and operation of the network should be as efficient as possible, so that the data exchange is as error-free, fast and energy efficient as possible. In particular, an additional aim is to achieve the widest possible range of data exchange for a hearing device.

The object is achieved according to the invention by a method having the features as claimed in the independent method claim and by a hearing device having the features as claimed in the independent hearing device claim. Advantageous configurations, extensions and variants form the subject matter of the dependent claims. In these the comments in relation to the method apply, mutatis mutandis, also to the hearing device, and vice versa. If method steps are described in the following, advantageous configurations for the hearing device are obtained in particular by the fact that the latter is designed to execute one or more of these method steps.

With the foregoing and other objects in view there is provided, in accordance with the invention, a method for operating a network having a plurality of hearing devices assigned to different users. Each of the hearing devices has an interface via which it is connected to at least one other of the hearing devices for a purpose of data exchange with the at least one other hearing device and other ones of the hearing devices. The method includes dividing the network into a plurality of subnets. The subnets are then connected to each other by one of the hearing devices being configured as a gateway in each of the subnets, for the exchange of data between the hearing devices of different ones of the subnets. Each of the hearing devices which is not configured as the gateway is assigned to exactly one of the subnets and is dynamically assigned to another one of the subnets or a new subnet, to increase transmission quality during the data exchange.

The method is used to operate a network containing a plurality of hearing devices assigned to different users. The network therefore has a plurality of hearing devices, which are each a node of the network and are connected to each other in the network for data exchange purposes. In the present case therefore, only hearing devices which are explicitly assigned to different users are considered. A hearing device is, in particular, a monaural or binaural hearing aid. In the case of a monaural hearing aid, a user only wears a single device on only one side of the head, in the case of a binaural hearing aid, a user wears two individual devices on different sides of the head. All hearing devices subscribed to the network are hearing devices of different users, i.e. no two hearing devices are assigned to the same user. In other words, the connection of two individual devices of a binaural hearing aid of an individual user is not considered here and nor is it an object, but rather in the case of two individual devices of a binaural hearing aid these are collectively referred to as “a hearing device”. The term “hearing device” here means all individual devices which are assigned to an individual user.

Each of the hearing devices has an interface via which it is connected to at least one of the other hearing devices for the purpose of data exchange with this hearing device and the other hearing devices. The interface is also referred to as a communication interface. The interface is preferably a wireless interface. The interface is suitably implemented as a WLAN, RF or Bluetooth antenna, or an antenna for communication by means of Zigbee or 5G. A given hearing device is not necessarily directly connected to every other hearing device, instead it is sufficient if each hearing device is connected to one other or more of the other hearing devices, in such a way that all hearing devices are at least indirectly connected to each other. If there is no direct or indirect connection between two hearing devices, these are not nodes of the same network.

The network can be divided into a plurality of subnets which are then connected to each other by one of the hearing devices being configured as a gateway in each of the subnets, for the exchange of data between the hearing devices of different subnets. An important aspect here is that the device that is used as a gateway is a hearing device and not a separate auxiliary device, which is not a hearing device. The hearing device that is configured as a gateway therefore performs an additional function to a regular hearing device function, namely an interface function between two subnets. A gateway is characterized in particular by the fact that it bundles the data exchange of a subnet and thus typically multiple hearing devices, and sends them collectively to another subnet. The hearing devices of different subnets are therefore only indirectly connected via the respective gateway. A single hearing device is either assigned to multiple subnets at the same time and is then a gateway in each of these subnets, or a gateway of a first subnet is positioned opposite a gateway of another, second subnet, so that the two gateways control the data exchange between the two subnets, preferably the entire data exchange. In the first case, two subnets overlap because the gateway is assigned to both subnets. In the second case, the first and second subnets each have a gateway, and the gateways are connected to each other so that the two subnets do not overlap, but each of the two gateways is assigned to only one of the two subnets. In the case of a subnet with only a single hearing device, this is also a gateway of the subnet.

Two gateways are directly connected to each other in a preferred configuration. In some cases, however, it is advantageous to use an auxiliary device, for example to bridge distances which are greater than the range of the gateways. In an equally suitable design, at least one relay is then arranged between two gateways via which the two gateways are indirectly connected. The relay is not a hearing device, but e.g. a router, computer or smartphone, so that the gateways are connected, for example, in a shared WLAN or via the internet.

Each of the hearing devices which is not configured as a gateway is assigned to exactly one subnet, i.e. only belongs to one subnet. On the other hand, depending on the design, a given gateway belongs to one or more subnets. This means that two suitable configurations are possible: firstly, a configuration in which each of the hearing devices, even if it is a gateway, is assigned to exactly one subnet. Secondly, a configuration in which a gateway is assigned to multiple subnets, but all other hearing devices that are not gateways are assigned to exactly one subnet. Both configurations can also be combined, so that one gateway is assigned to only one subnet, while another is assigned to multiple subnets. If a gateway belongs to only one subnet, this gateway is connected to a gateway of another subnet. If a gateway belongs to multiple subnets, then these subnets overlap at a selected point and in particular exclusively at this gateway, which is then a shared gateway of the two subnets. However, a hearing device that is not a gateway always belongs to only a single subnet.

In addition, as part of the method each of the hearing devices is dynamically assigned to a different, existing subnet or a new subnet, in order to increase the transmission quality during data exchange. In other words, depending on the configuration in which the transmission quality is better, subnets are formed or dissolved dynamically and the hearing devices are also dynamically assigned to them. In total, the hearing devices are thus connected to each other such that the transmission quality is optimized. The essential point is that this takes place dynamically, i.e. it is checked regularly and periodically whether a configuration other than the current configuration will lead to a better transmission quality, and if so, this other configuration will be applied. In a suitable design, this check is carried out by the hearing devices themselves, for example by a single hearing device in the network, which for this purpose is configured as a master, or by a plurality or all of the hearing devices, the results of which are then compared with regard to their configuration. The term “configuration” refers to which specific hearing device is directly connected to which other hearing device, how many subnets are formed, which hearing device is assigned to which subnet, which hearing devices are configured as a gateway, or a combination of these. Overall therefore, the division of the network into subnetworks and the assignment of hearing devices to these subnetworks is not static, i.e. fixed once and for all, but variable, in fact dynamic, and is also varied with the aim of optimizing the overall transmission quality during the data exchange as far as possible.

In a suitable design, the transmission quality is measured as a transmission speed or as a data rate or as an error rate for the data exchange between any hearing devices in the network. For example, from the various transmission speeds, data rates or error rates an average value is then generated, which is then optimized by changing the configuration. Other metrics and assessments of transmission quality are also entirely conceivable and suitable, the essential point being that the communication between the hearing devices is optimized and thus improved.

During the data exchange, data is exchanged between the hearing devices. This data may include audio data, setting data, or other data, or a combination of these. In the data exchange a certain volume of data is also transmitted, the size of which significantly influences the transmission quality. Because the available bandwidth for the data exchange is usually limited, too much data will result in corresponding transmission losses and errors.

The invention is based in particular on the finding that a direct connection of two hearing devices in the form of a peer-to-peer connection, i.e. without an intermediary auxiliary device, is particularly advantageous. Such a peer-to-peer connection makes it easy to exchange data efficiently. In the case of multiple hearing devices, every hearing device would then be connected to every other hearing device, resulting in a correspondingly high number of direct connections. The resulting network is then a complete peer-to-peer network in which each node is connected to every other node. The demand on a single interface in terms of power and bandwidth increases accordingly.

A key idea of the invention is then, in particular, to simplify the networking of hearing devices by consolidating the connections between hearing devices, so that every hearing device is not necessarily connected to every other hearing device. The networking of hearing devices is structured in such a way that not only are they directly connected to each other in pairs for data exchange, but also that purely indirect connections are also possible. Such indirect connections are created, in particular, by individual hearing devices being configured as gateways and then being used to reduce the number of connections and also the required bandwidth. In addition, this advantageously allows the network to cover distances that are larger than the range of the interface of a hearing device. Overall, this reduces the energy requirements of each hearing device. By using the transmission quality as a measure for optimizing the network, a particularly energy-efficient configuration is achieved and a particularly fast and error-free data exchange can be realized.

In a preferred embodiment, within at least one subnet, preferably within each subnet, two of the hearing devices are connected in the form of a peer-to-peer connection, i.e. connected to each other directly. Accordingly, while the network as a whole is not a pure peer-to-peer network, the individual subnets of the network are each implemented as peer-to-peer networks.

In a suitable embodiment, within at least one subnet, preferably within each subnet, every hearing device is directly connected to every other hearing device of the subnet in the form of a peer-to-peer connection, i.e. directly connected to each other, so that the subnet is a complete peer-to-peer network. In a single subnet with, for example, n hearing devices, each hearing device then has n−1 connections to the other hearing devices, so that a total of n*(n−1) connections are formed in the subnet. A subnet which is implemented as a complete peer-to-peer network is also called a mesh network on account of the pairwise connections between all hearing devices. Multiple mesh networks are then connected to each other via respective gateways.

A design in which the network is dynamically configured depending on the number of nodes in the subnetworks is particularly advantageous. The aim is to divide the hearing devices into multiple sub-networks in such a way as to obtain a distribution that is as balanced as possible. In a suitable design to this end, the network is divided into at least two subnets, each having a number of nodes which indicates how many hearing devices are assigned to the respective subnet. The hearing devices are then distributed among the two subnets in such a way that the numbers of nodes are matched to each other. In other words, a difference in the number of nodes in different subnets is reduced by a redistribution of the hearing devices. This balancing of the number of nodes ensures, on the one hand, that the data exchange between the subnetworks via the gateways is balanced in such a way that approximately the same volume of data is transmitted in both directions. If the subnetworks had different sizes, the volume of data would typically be larger in one direction than in the other, so that a correspondingly higher bandwidth is required and a correspondingly powerful hearing device as the gateway. Furthermore, by balancing the number of nodes, the volume of data within the originally larger subnet is also reduced and thus the requirements on the hearing devices in this subnet are reduced by the same amount. The other subnet now accepts additional nodes, resulting in a correspondingly increased volume of data. It is assumed that this can be absorbed in the other subnet. This is typically justified, since all hearing devices can be assumed to have at least roughly similar performance and above all, a similar bandwidth.

Alternatively, or in addition to dividing the hearing devices into existing subnets, or starting from initially only one subnet, it is advantageous to create a new subnet in order to increase the transmission quality by rearranging some hearing devices from the original subnets into the new subnet. For this purpose, in a suitable design a new subnet is created if a number of hearing device nodes of an existing subnet exceeds a maximum number. A subset of the hearing devices of the existing subnet is then assigned to the new subnet, thus reducing the number of nodes in the existing subnet. In other words, if a single subnet becomes too large, a portion of the nodes are relocated to a new subnet, so that the amount of data in the existing subnet is reduced accordingly and higher transmission quality is achieved. This is particularly advantageous in combination with creating a balance between multiple subnetworks as described above. If a new subnet is created, one of the hearing devices in the new subnet will also be configured as a gateway for connection to the existing subnet.

An existing subnet is advantageously removed, i.e. closed, if this would result in no or only minimal loss of transmission quality. This also allows the number of subnets to be reduced again if there is no need for them. The use of as few subnets as possible is advantageous, as this means fewer gateways are required, and as described above gateways are generally more heavily loaded during data exchange than hearing devices which are not configured as a gateway. The loading caused by the data exchange is then distributed more evenly overall.

In a preferred design, at least one subnet is formed as a ring network in which a given hearing device is connected to only two other hearing devices so that the data exchange within the subnet takes place from hearing device to hearing device in turn. A ring network is therefore also a peer-to-peer network, as similar devices, in this case hearing devices, are connected to each other. In an advantageous design, all of the subnets are implemented as ring networks. However, a combination of one or more ring networks with one or more mesh networks or other types of peer-to-peer networks, as described above, is also possible and suitable. A ring network is characterized by a particularly small number of connections, which are formed in such a way that the hearing devices of the subnet are connected one after the other in a chain. In a single ring network with, for example, n hearing devices, each hearing device then has only two connections to other hearing devices, so that a total of n connections are then formed in the subnet. Reducing the number of connections also reduces the data traffic and bandwidth required for data exchange on the subnet, resulting in improved transmission quality. A ring bus is then formed in the ring network, to which each of the hearing devices writes its respective data and the data are read by other hearing devices. The data can then be visualized as traveling around a ring from one hearing device to the next hearing device. A gateway in the ring network sends the data, on the one hand, to the following hearing device in the ring network and, on the other hand, to another subnet as required.

The network is preferably divided into at least two subnets, each of which is a ring network and each of which has a circulation period which indicates how long data takes to travel around the subnet. The hearing devices are then distributed among the two subnets in such a way that the circulation periods are matched to each other. In a similar way to the balancing of the numbers of nodes described above, the data exchange load is then distributed among several subnets. As the circulation period often depends on the number of nodes, similarly advantageous effects are obtained. However, the circulation period is a more precise measure of the transmission quality within a subnet than the number of nodes. By aligning the circulation periods of different ring networks, a corresponding improvement in the transmission quality is therefore achieved.

Ideally, a new subnet is generated if a circulation period of an existing subnet, which is a ring network, exceeds a maximum circulation period. The circulation period is defined as previously described. A subset of the hearing devices of the existing subnet is then assigned to the new subnet, thus reducing the circulation period in the existing subnet. In other words, if the maximum circulation period is exceeded, a portion of the hearing devices of one ring network is relocated to a new subnet which is specially formed to reduce the circulation period in the original subnet. This is based on the idea that the circulation period typically depends primarily on the number of nodes and is therefore reduced in a straightforward way by reducing the number of nodes. Instead of forming a single, large ring network with many hearing devices, the hearing devices are distributed over multiple subnets, specifically multiple ring networks, which are connected by one or more gateways, so that the overall transmission quality is optimized.

The selection of a hearing device as a gateway can in principle be made at random. However, it is preferable that each hearing device has an operational capability and in a particular subnet the hearing device that has the highest operational capability is configured as a gateway. For this purpose, the respective operational capability is determined, e.g. by the respective hearing device itself, and compared with the operational capabilities of the other hearing devices, e.g. by sending the operational capability to the other hearing devices during data exchange. In this case, a specific selection is thus made which guarantees an improved operation of the network and thus a particularly reliable data exchange. This is achieved in this case because in each subnet, the hearing device which has the highest capacity is selected as the gateway. This capacity is expressed by the operational capability of a given hearing device compared to the operational capability of the other hearing devices. The operational capability indicates how secure and reliable the operation of the hearing device is at the given time, and preferably also how secure and reliable the operation of the hearing device is expected to be in the future. This ensures that the data exchange with other subnets is controlled by the hearing device most capable of doing so. If a master is defined in the subnet, the hearing device with the highest operational capacity is similarly selected for this role.

The operational capability of the hearing device is derived in particular from an operating parameter of the hearing device. The operating parameter is a variable that typically changes dynamically during the operation of the hearing device, thereby indicating a specific condition of the hearing device at a given time. In particular, the operating parameter quantifies an operationally relevant characteristic of the hearing device or component of the hearing device. The operating parameter is also directly or indirectly a measure of the current and/or future performance of the hearing device with regard to its functionality. This makes the operating parameter particularly suitable for determining whether the hearing device is suitable as a gateway or whether another hearing device is more suitable.

In a particularly advantageous design, the operational capability is determined based on a state of charge of an energy storage unit of the respective hearing device, so that the hearing device which has the highest state of charge in the respective subnet is configured as the gateway. This ensures that the hearing device with the largest energy reserve controls data exchange with another subnet, ensuring the longest possible operation of the network as a whole. The state of charge is an operating parameter of the hearing device. In the operation of the hearing device, the state of charge constantly decreases due to the hearing device performing one or more functions, e.g. modification in a signal processor or outputting sound via a receiver. Specifically in the case of a gateway, it can typically—but not necessarily—be assumed that the energy consumption will increase due to the additional function of controlling the data exchange and that the state of charge will decrease correspondingly faster compared to the role as a basic node without an interface function. Therefore, it is appropriate to select and configure the hearing device with the highest charge level as the gateway.

In an advantageous design the operational capability is determined based on a transmission and/or reception quality of the hearing device, so that the hearing device which has the highest transmission and/or reception quality in the respective subnet is configured as a gateway. This ensures that the hearing device, the interface of which has the best transmission quality or reception quality, or both, controls the data exchange with another subnet. For example, the transmission and/or reception quality is quantified by an average signal strength with which the hearing device receives data from or sends data to other hearing devices, or both. For example, the transmission and/or reception quality depends on the position of a hearing device relative to other hearing devices and to obstacles that may be present. Furthermore, the transmission and/or reception quality depends, for example, on the type and design of an antenna of the hearing device which is used for transmitting and/or receiving during the data exchange.

A combination of more than one of the above approaches for determining the operational capability is also advantageous, so that it is determined depending on multiple different operating parameters of a hearing device. For example, in this case the different operational parameters are treated with different priorities.

In a convenient design a subnet is connected to a plurality of other subnets by the appropriate number of hearing devices each being configured as a gateway for connection to exactly one of the other subnets, so that a given gateway is connected to only one gateway of another subnet. This creates a 1:1 connection and ensures that a single gateway is not overloaded, but rather controls the connection to only one other subnet. If the operational capability of a gateway is taken into account in the selection of a gateway, hearing devices that are already configured as a gateway are, in particular, not taken into account.

Another advantageous configuration is one in which a first subnet is connected to a second subnet by only one of the hearing devices being configured as a gateway in both the first subnet and the second subnet. This leads to the above-mentioned case where a single hearing device is assigned to multiple subnets at the same time. This case, in which a hearing device is configured as a gateway for two different subnets, also turns out to be the only case in which a single hearing device is assigned to two subnets at the same time. In all other cases, a single hearing device is always assigned to a single subnet. Even in the case that two subnets are connected via two gateways, these two gateways are assigned to only one subnet each. The dual use of a single hearing device as a gateway in both a first and a second subnet is advantageous in the respect that only one hearing device needs to be configured and operated as a gateway in order to connect two subnets together. These two subnets then overlap at a selected point and, in particular, exclusively at the gateway, which is then a common gateway. The other hearing devices of the first subnet are then exclusively indirectly connected to the other hearing devices of the second subnet via the common gateway.

Advantageously, such hearing devices as are located within a maximum distance of each other, i.e. which are in spatial proximity to each other, are jointly assigned to a subnet. In a suitable design, the maximum distance is between 1 m and 10 m. In a suitable design, the maximum distance corresponds to the range of the interface of a particular hearing device. Accordingly, the maximum distance for each of the hearing devices may differ in principle, depending on their design. A connection to hearing devices located further away is preferably realized by means of a gateway in the subnet. In this way, local subnets are formed which are spatially separated from each other and connected to each other by the respective gateways.

In order to further improve the transmission quality, a compression method is preferably used for data exchange. The compression method is preferably implemented in a specific control unit of a particular hearing device. The purpose of the compression method is to reduce the volume of data transmitted by the hearing device during data exchange. This saves overall bandwidth and improves the transmission quality accordingly. In addition, correspondingly larger subnets can be implemented, i.e. subnets with more nodes, than without compression methods.

A given hearing device is designed to carry out a method as described above. Preferably, the hearing device has a control unit for this purpose. In the control unit, the method is implemented, in particular, in software or circuit technology, or a combination of these. For example, the control unit is designed as a microprocessor or as an ASIC or a combination of these.

A hearing device is preferably a monaural or binaural hearing aid. A binaural hearing aid contains two separate devices, which are worn by the user on different sides, i.e. in or on the left and right ears. A monaural hearing aid only has a single device, which is worn by the user on or in the left or right ear. Especially in the case of a binaural hearing aid, in an advantageous design one of the individual devices contains the interface for data exchange with other hearing aids, whereas the other device does not directly exchange data with other hearing aids, but directly subscribes to the interface on the network via the individual device. This arrangement saves energy during operation, since both individual devices are connected to the network via only one interface.

Each hearing aid is preferably used for treating a hearing-impaired user. To this end, the hearing aid has a microphone which captures sound from the surroundings and generates an electrical input signal. This is fed to a signal processor of the hearing device for modification. The signal processor is preferably a part of the control unit. The modification takes place in particular on the basis of an individual audiogram of the user which is assigned to the hearing device, so that an individual hearing deficit of the user is compensated. As a result the signal processor outputs an electrical output signal, which is then converted back into sound and output to the user via a receiver of the hearing aid.

Other features which are considered as characteristic for the invention are set forth in the appended claims.

Although the invention is illustrated and described herein as embodied in a method for operating a network, and a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of a hearing device;

FIG. 2 is an illustration showing a network;

FIG. 3 is an illustration showing a variant of the network;

FIG. 4 is an illustration showing another variant of the network;

FIG. 5 is an illustration showing another variant of the network;

FIG. 6 is an illustration showing another variant of the network;

FIG. 7 is an illustration showing another variant of the network;

FIG. 8 is an illustration showing another variant of the network;

FIG. 9 is an illustration showing another variant of the network; and

FIG. 10 is an illustration showing another variant of the network.

### DETAILED DESCRIPTION OF THE INVENTION

Referring now to the figures of the drawings in detail and first, particularly to FIG. 1 thereof, there is shown a hearing aid 2, which is used here specifically for treating a hearing-impaired user N, not explicitly shown in FIG. 1. To this end the hearing aid 2 has a microphone 4, which captures sound from the surroundings and generates an electrical input signal. This is fed to a signal processor 6 of the hearing aid 2 for modification. The modification is carried out in particular on the basis of an individual audiogram of the user N which is assigned to the hearing aid 2, so that an individual hearing deficit of the user N is compensated. The result of the signal processor 6 is to output an electrical output signal, which is then converted back into sound via a receiver 8 of the hearing aid 2 and output to the user N. In the exemplary embodiment shown, the signal processor 6 is part of a control unit 10 of the hearing aid 2.

The hearing aid 2 is also subscribed to a network 12 as a node for exchanging data with other hearing aids 2 assigned to other users N. Example networks 12 are shown in FIGS. 2 to 10.

The hearing devices 2 considered here are explicitly assigned to different users N. Each hearing device 2 here is a monaural or binaural hearing aid 2. In the case of a monaural hearing aid 2, a user N only wears a single device on only one side of the head, in the case of a binaural hearing aid 2, a user wears two individual devices on different sides of the head. All hearing aids 2 subscribed to the network 12 are hearing aids 2 of different users N, i.e. no two hearing aids 2 are assigned to the same user N.

Each of the hearing aids 2 has an interface 14 via which it is connected to at least one of the other hearing aids 2 for data exchange with this and the other hearing aids 2. The networks 12 shown as examples are wireless networks 12, the interfaces 14 are accordingly wireless interfaces, e.g. WLAN, Bluetooth or RF antennas.

A method for operating the network 12 is described below by reference to FIGS. 2 to 10. The network 12 essentially has a plurality of hearing aids 2, which are assigned to different users N. The network 12 can be divided into a plurality of subnets 16, 18 which are then connected to each other by one of the hearing aids 2 being configured as a gateway 20 in each of the subnets 16, 18 for the data exchange between the hearing devices 2 of different subnets 16, 18. Each of the hearing devices 2 which is not configured as a gateway 20 is assigned to exactly one subnet 16, 18 and is dynamically assigned to another existing subnet 16, 18 or a new subnet 16, 18 to increase transmission quality during the data exchange.

A given hearing aid 2 is not necessarily directly connected to every other hearing aid 2, instead it is sufficient if each hearing aid 2 is connected to one or more of the other hearing aids 2 in such a way that all hearing aids 2 are at least indirectly connected to each other. If there is no direct or indirect connection between two hearing aids 2, they are not nodes of the same network 12.

In the present case the gateway 20 is explicitly formed by a hearing aid 2 and not a separate auxiliary device, which is not a hearing aid 2. The hearing aid 2 which is configured as the gateway 20 therefore performs an additional function in addition to a regular hearing aid function, namely an interface function between two subnets 16, 18. The gateway 20 in this case is thus characterized by the fact that it bundles the data exchange of a subnet 16, 18 and sends it collectively to another subnet 16, 18, more precisely to a corresponding gateway 20 of the other subnet 16, 18. The hearing aids 2 of different subnets 16, 18 are therefore only indirectly connected via the gateway 20. In the exemplary embodiments of FIGS. 2 to 7 and 9, a gateway 20 in one subnet 16, 18 is located opposite another gateway 20 in another subnet 16, 18, so that the two gateways 20 control the data exchange between the two subnets 16, 18. In a subnet 16, 18 with only one single hearing aid 2, this is also a gateway 20 of the subnet 16, 18, as shown in FIG. 8. Finally, in FIG. 10 a single hearing aid 2 serves as a gateway 20 for a first and a second subnet 16, so that the two subnets 16 overlap.

FIG. 2 shows an exemplary embodiment in which the network 12 is divided into two subnets 16. Further, in FIG. 2 the two gateways 20 are directly connected to each other. In some cases, however, as in the alternative of FIG. 3, it is advantageous to use an auxiliary device 22, for example to cover distances which are greater than the range of the gateways 20. In FIG. 3, at least one auxiliary device 22, namely a relay, is therefore arranged between the two gateways 20, via which the two gateways 20 are indirectly connected. The relay is not a hearing device 2, but e.g. a router, computer or smartphone, so that the gateways 20 are connected, for example, in a shared WLAN or via the internet, as shown in FIG. 3.

In the exemplary embodiments, each of the hearing aids 2 which is not a gateway 20 is assigned to exactly one subnet 16, 18. As part of the method, each of the hearing aids 2 is dynamically assigned to a different, existing subnet 16, 18 or a new subnet 16, 18, in order to increase the transmission quality during data exchange. In other words, depending on the configuration in which the transmission quality is better, subnets 16, 18 are formed or dissolved dynamically and the hearing aids 2 are also assigned to them dynamically. Overall, the hearing aids 2 are connected to each other in such a way that the transmission quality is optimized. The essential point is that this takes place dynamically, i.e. it is checked regularly and periodically whether a configuration other than the current configuration will lead to a better transmission quality, and if so, this other configuration is applied. The term “configuration” here refers to which specific hearing device 2 is directly connected to which other hearing device 2, how many subnets 16, 18 are formed, which hearing device 2 is assigned to which subnet 16, 18, which hearing devices 2 are configured as a gateway 20, or a combination of these. The division of the network 12 into subnetworks 16, 18 and the assignment of the hearing devices 2 to these subnetworks 16, 18 is thus precisely not static, i.e. fixed once and for all, but variable, in fact dynamic, and is also varied with the aim of optimizing the overall transmission quality during the data exchange as far as possible. Accordingly, the situations shown in FIGS. 2 to 10 can be dynamically transformed into each other.

During the data exchange, data is exchanged between the hearing devices 2. This data may include audio data, setting data, or other data, or a combination of these. In the data exchange a certain volume of data is also transmitted, the size of which significantly influences the transmission quality. Because the available bandwidth for the data exchange is usually limited, an excessive amount of data will result in corresponding transmission losses and errors. The transmission quality in this case is measured, for example, as a transmission rate or as a data rate or as an error rate in the data exchange in the network 12, for example as the average transmission quality of all connections between any two hearing aids 2. Connections between hearing aids 2 or between hearing aids 2 and auxiliary devices 22 or between auxiliary devices 22 are shown schematically in FIGS. 2 to 10 as arrows.

In this case, the networking of hearing devices 2 is structured in such a way that not only are these connected directly to each other in pairs for data exchange, but also that purely indirect connections are also possible. Such indirect connections are created, in particular, by individual hearing devices 2 being configured as gateways 20 and then being used to reduce the number of connections and also the required bandwidth. In addition, this may also allow the network to cover distances that are larger than the range of the interface 14 of a hearing device. Overall, this also reduces the energy requirements of each hearing device 2.

In the exemplary embodiments given in FIGS. 2 to 10, within one or more subnets 16,18 any two hearing aids 2 are directly connected to each other, in the manner of a peer-to-peer connection. Accordingly, while the network 12 as a whole is not a pure peer-to-peer network, the individual subnets 16, 18 of the network 12 are each implemented as peer-to-peer networks.

A subnet 16 which is formed in the manner of a complete peer-to-peer network, in which each hearing aid 2 is connected to every other hearing aid 2, is also called a mesh network 16 on account of the maximum number of pairwise connections between the individual hearing aids 2. A plurality of mesh networks 16 are then connected to each other as shown via respective gateways 20. In FIGS. 2 and 3 mesh networks 16 are shown, but the descriptions of these also apply analogously to other peer-to-peer networks with fewer connections.

In one design of the method, the network 12 is configured dynamically depending on the actual number of nodes in the subnets 16, 18. The aim is to divide the hearing devices 2 into multiple sub-networks 16, 18 in such a way as to obtain a distribution that is as balanced as possible. This is shown in FIGS. 4 and 5, in which the network 12 is divided into at least two subnets 16, 18, each having a number of nodes which indicates how many hearing devices 2 are assigned to the respective subnet 16, 18. Based on the configuration in FIG. 4 with by way of example two and four nodes in the two subnets 16, 18, the hearing aids 2 are now distributed over the two subnets 16, 18 as shown in FIG. 5, in such a way that the numbers of nodes are matched. In the example shown, each subnet 16, 18 then has three nodes. On the one hand, this balances the data exchange between the subnets 16, 18 via the gateways 20 in such a way that approximately the same volume of data is transmitted in both directions. Furthermore, by balancing the number of nodes, the volume of data within the originally larger subnet 16, 18 is also reduced and thus the requirements on the hearing devices 2 in this subnet 16, 18 are reduced accordingly. The other subnet 16, 18 now accepts additional nodes, resulting in a correspondingly increased volume of data, assuming that this can be absorbed in the other subnet 16, 18. In FIGS. 4 and 5, the two gateways 20 have been retained, but this is not mandatory. In a variant not shown, when the number of nodes is balanced one or more other hearing devices 2 are configured as gateways 20.

Alternatively, or in addition to dividing the hearing aids 2 into existing subnets 16, 18, or assuming initially only one subnet 16, 18, in the exemplary embodiment of FIGS. 6 and 7 a new subnet 16, 18 is advantageously created in order to increase the transmission quality by moving some hearing devices 2 from the original subnet 16, 18 into the new subnet 16, 18. For this purpose, a new subnet 16, 18 is generated whenever a number of hearing aids 2 acting as nodes of an existing subnet 16, 18 as shown in FIG. 6 exceeds a maximum number. A subset of the hearing aids 2 of the existing subnet 16, 18 is then assigned to the new subnet 16, 18 as shown in FIG. 7, thus reducing the number of nodes in the existing subnet 16, 18. If a new subnet 16, 18 is created, one of the hearing aids 2 in the new subnet 16, 18 will also be configured as a gateway 20 for connection to the existing subnet 16, 18.

The concepts explained on the basis of FIGS. 4 and 5 as well as 6 and 7 are also entirely reversible. In addition, in a variant not shown, an existing subnet 16, 18 is removed, i.e. closed, if this would result in no or only minimal loss of transmission quality. This also allows the number of subnets 16, 18 to be reduced again if there is no need for them. This means that fewer gateways 20 are then needed.

As an alternative to a mesh network 16, in addition to general peer-to-peer networks, ring networks 18 are also particularly advantageous. FIG. 8 shows a network 12 with a subnet 18, which is implemented as a ring network 18. In a ring network 18, a given hearing aid 2 is only connected to two other hearing aids 2, so that the data exchange within the subnet 18 takes place from hearing aid 2 to hearing aid 2 in turn. A combination of one or more ring networks 18 with one or more mesh networks 16 is also possible and suitable. A ring bus is then formed in the ring network, to which each of the hearing aids 2 writes its respective data and the data are read by other hearing aids 2. The data then travel around a ring from one hearing aid 2 to the next hearing aid 2. A gateway 20 in the ring network sends the data, on the one hand, to the following hearing aid 2 in the ring network and, on the other hand, to another subnet 16, 18 as required.

Due to the small number of nodes the exemplary embodiments of FIGS. 4 to 7 can be specifically construed both as configurations of mesh networks 16 and ring networks 18. However, depending on the connections of the hearing aids 2 within a given subnet 16, 18 these subnets 16, 18 are each clearly identifiable as a ring network or as a mesh network or an intermediate form of these, but overall always as a peer-to-peer network. In order to illustrate the different designs, in FIGS. 4 and 6 dashed arrows are drawn, which represent connections in case a mesh network 16 is present. If a ring network 16 is used, these dashed connections shown in the diagram are not present.

FIGS. 4 and 5 can therefore also be construed as an alternative exemplary embodiment, in which the network 12 is divided into at least two subnets 18, each of which is a ring network 18 and each of which has a circulation period which indicates how long data takes to circulate around the subnet 18. The hearing aids 2 are then distributed among the two subnets 18 in such a way that the circulation periods are matched to each other. In a similar way to the balancing of the numbers of nodes described above, the data exchange load is then distributed among several subnets 18.

Likewise, FIGS. 6 and 7 can also be taken to be an alternative exemplary embodiment in which a new subnet 18 is created if a circulation period of an existing subnet 18, which is a ring network 18, exceeds a maximum circulation period. The circulation period is defined as previously described. A subset of the hearing aids 2 of the existing subnet 18 is then assigned to the new subnet 18, thus reducing the circulation period in the existing subnet 18.

When changing the assignment of hearing aids 2 to subnets 16, 18, it is also entirely possible and sometimes advantageous to change the type of the subnet 16, 18, i.e. to convert a ring network 18 into a mesh network 16, or generally into another peer-to-peer network or vice versa.

In one embodiment a subnet 16, 18 is connected to a plurality of other subnets 16, 18 by the appropriate number of hearing devices 2 each being configured as a gateway 20 for connection to exactly one of the other subnets 16, 18, so that a given gateway 20 is connected to only one gateway 20 of another subnet 16, 18. An exemplary embodiment of this is shown in FIG. 9. There, the network 12 is divided into three subnets 16, 18, where two of the subnets 16, 18 are assigned only one single node. On the other hand, a plurality of nodes are assigned to the third subnet 16 and, most importantly, two of these nodes are configured as gateways 20 for connecting this third subnet 16 to each of the other subnets 16, 18. It is also immediately clear that further variants, not shown, are obtained from the fact that the subnets 16, 18 are designed differently, for example, they have different numbers of nodes, or are implemented as a ring network 18 or a mesh network 16 or an intermediate form of these, and at least in general as peer-to-peer network. A design is also possible in which the subnets 16, 18 are connected in pairs via gateways 20, so that e.g. a higher-level ring network of subnets 16, 18 or another type of branching structure of subnets 16, 18 is formed.

FIG. 10 shows a configuration in which a first subnet 16 is connected to a second subnet 16 by a single one of the hearing devices 2 being configured as a gateway 20 in both the first subnet 16 and the second subnet 16. This leads to the case where a single hearing aid 2 is assigned to multiple subnets 16 at once. This case, in which a hearing aid 2 is configured as a gateway 20 for two different subnets 16, is in particular also the only case in which a single hearing aid 2 is assigned to two subnets 16 at the same time. In all other cases, a single hearing aid 2 is always assigned to only one subnet 16, as can be seen e.g. from FIGS. 2 to 7 and 9. Even in the case where, as in FIGS. 2 to 7 and 9, two subnets 16 are connected via two gateways 20, these two gateways 20 are each assigned to only one subnet 16. The dual use of a single hearing aid 2 as a gateway 20 in both a first and a second subnet 16, as shown for example in FIG. 10, means that only one hearing aid 2 must be configured and operated as a gateway 20 in order to connect two subnets 16 to each other. These two subnets 16 then overlap at a selected point and, in particular, exclusively at the gateway 20, which is then a common gateway 20. The other hearing aids 2 of the first subnet 16 are then exclusively connected to the other hearing aids 2 of the second subnet 16 indirectly via the common gateway 20. Although FIG. 10 shows two mesh networks 16, the designs apply analogously to ring networks 18 or a combination of a ring network 18 and a mesh network 16.

The selection of a hearing aid 2 as gateway 20 can in principle be random, i.e. arbitrary. However, in a possible design each of the hearing aids 2 has an operational capability and in a particular subnet 16, 18 the hearing aid 2 that has the highest operational capability is configured as a gateway 20. The operational capability of the hearing aid 2 in the present case is derived from an operating parameter of the hearing aid 2. The operating parameter is a variable that typically changes dynamically during operation of the hearing aid 2, thereby indicating a specific condition of the hearing aid 2 at a given time. In this case the operating parameter quantifies an operational characteristic of the hearing aid 2 or a component of the hearing aid 2. For example, the operational capability is determined based on a state of charge of the energy storage unit 24 of the respective hearing device 2, so that the hearing device 2 which has the highest state of charge in the respective subnet 16, 18 is configured as the gateway 20. Alternatively or additionally, the operational capability is determined using a transmission and/or reception quality of the hearing device 2, so that the hearing device 2 which has the highest transmission and/or reception quality in the respective subnet 16, 18 is configured as a gateway 20. This ensures that the hearing device 2, the interface 14 of which has the best transmission quality or reception quality, or both, controls the data exchange with another subnet 16, 18.

In this case, such hearing devices 2 as are located within a maximum distance from each other, i.e. which are in spatial proximity to each other, are jointly assigned to a subnet 16, 18. For example, the maximum distance is between 1 m and 10 m, or the same as the range of the interface 14 of a particular hearing aid 2. In addition, in this case a compression method is used for data exchange, which is implemented in a respective control unit 10 of each hearing device 2 and which serves to reduce the volume of data that is transmitted by the hearing device 2 during data exchange. However, the assignment depending on the maximum distance and the use of a compression method are essentially optional and can also be used independently of each other and independently of the specific configurations of the network 12 shown.

The following is a summary list of reference numerals and the corresponding structure used in the above description of the invention:
2 hearing device
4 microphone
6 signal processor
8 receiver
10 control unit
12 network
14 interface
16 subnet, peer-to-peer network, mesh network
18 subnet, ring network
20 gateway
22 auxiliary device
24 energy storage unit
N user

1. A method for operating a network having a plurality of hearing devices assigned to different users, each of the hearing devices having an interface via which it is connected to at least one other of the hearing devices for a purpose of data exchange with the at least one other hearing device and other ones of the hearing devices, which comprises the steps of:
dividing the network into a plurality of subnets, the subnets are then connected to each other by one of the hearing devices being configured as a gateway in each of the subnets, for the exchange of data between the hearing devices of different ones of the subnets, wherein each of the hearing devices which is not configured as the gateway is assigned to exactly one of the subnets and is dynamically assigned to another one of the subnets or a new subnet, to increase transmission quality during the data exchange.

2. The method according to claim 1, wherein within at least one of the subnets, two of the hearing devices are directly connected to each other in a form of a peer-to-peer connection.

3. The method according to claim 1, which further comprises dividing the network into at least two said subnets, each of the two subnets having a number of nodes which indicates how many of the hearing devices are assigned to a respective one of the subnets, the hearing devices being distributed among the two subnets in such a way that the numbers of nodes are matched to each other.

4. The method according to claim 1, which further comprises generating the new subnet if a number of the hearing devices acting as nodes of an existing subnet of the subnets exceeds a maximum number, and wherein a subset of the hearing devices of the existing subnet is assigned to the new subnet, thus reducing a number of the nodes in the existing subnet.

5. The method according to claim 1, wherein a given subnet of the subnets is formed as a ring network, in which a given hearing device of the hearing devices is connected to only two others of the hearing devices, so that the data exchange within the given subnet takes place from hearing device to hearing device in turn.

6. The method according to claim 1, which further comprises dividing the network into at least two said subnets, each of which is a ring network and each of which has a circulation period which indicates how long the data takes to circulate around each of the two subnets, wherein the hearing devices are distributed among the two subnets in such a way that circulation periods are matched to each other.

7. The method according to claim 1, which further comprises generating the new subnet if a circulation period of an existing subnet of the subnets, which is a ring network, exceeds a maximum circulation period, and a subset of the hearing devices of the existing subnet is assigned to the new subnet, thus reducing the circulation period in the existing subnet.

8. The method according to claim 1, wherein each of the hearing devices has an operational capability, wherein in a particular subnet of the subnets, a hearing device of the hearing devices which has a highest operational capability is configured as the gateway.

9. The method according to claim 8, which further comprises determining the operational capability using a state of charge of an energy storage unit of a respective hearing device of the hearing devices, so that the respective hearing device which has a highest state of charge in a respective subnet of the subnets is configured as the gateway.

10. The method according to claim 8, which further comprises determining the operational capability using a transmission and/or reception quality of the hearing device, so that the hearing device which has a highest transmission and/or reception quality in a respective subnet of the subnets is configured as the gateway.

11. The method according to claim 1, wherein a subnet of the subnets is connected to a plurality of other ones of the subnets by an appropriate number of the hearing devices each being configured as the gateway for connection to exactly one of the other subnets, so that a given gateway is connected to only one gateway of another one of the subnets.

12. The method according to claim 1, wherein a first subnet of the subnets is connected to a second subnet of the subnets by a single one of the hearing devices being configured as the gateway in both the first subnet and the second subnet.

13. The method according to claim 1, wherein the hearing devices which are within a maximum distance from each other are jointly assigned to a subnet of the subnets.

14. The method according to claim 1, which further comprises using a compression method for the data exchange.

15. A hearing device, comprising:
a controller programmed to carry out the method according to claim 1.
